(19) United States
(12) Patent Application Publication
(10) Pub. No.: US 2025/0186294 A1
(43) Pub. Date: Jun. 12, 2025

(54) MASSAGE MACHINE

(71) Applicant: FUJI Medical Instruments MFG. CO., LTD., Osaka (JP)

(72) Inventors: Masafumi TAKARABE, Osaka (JP); Toshihisa YOSHIDA, Osaka (JP); Kentaro ODE, Osaka (JP)

(73) Assignee: FUJI Medical Instruments MFG. CO., LTD., Osaka (JP)

(21) Appl. No.: 18/919,099

(22) Filed: Oct. 17, 2024

(30) Foreign Application Priority Data
Dec. 7, 2023 (JP) 2023-206761

(51) Int. Cl. A61H 9/00

(52) U.S. Cl. CPC A61H 9/0078; A61H 2201/0149; A61H 2201/1654; A61H 2201/5028; A61H 2201/5061; A61H 2201/5071

(57) ABSTRACT

A massage machine 100 comprises a detection part 2 and a determination part 32. The detection part 2 detects the pressure of airbag 1. The determination part 32 determines, based on the detection result of detection part 2, the presence or the absence of contact of airbag 1 with a person to be treated. The massage machine 100, when the determination part 32 determines that there is the contact, starts treatment by the airbag 1.

### RELATED APPLICATIONS

The present invention claims Priority to and from Japanese Patent Application 2023-206761 filed on Dec. 7, 2023. The entire contents disclosed therein are incorporated herein by reference.

### FIELD OF THE INVENTION

The present invention relates to a massage machine.

### BACKGROUND OF THE INVENTION

Conventionally, a massage machine, which uses an airbag to treat a person to be treated, has been known. For example, in the massage machine of Japanese patent Publication No. 2020-36716, an air cell (airbag) is placed at a body-support part such as a seat part, a backrest part, a pillow part, a footrest (ottoman) part and an armrest part and the like. Between the air cell and the body-supporting part, pressure sensors are disposed for detecting massage strength applied to the user.

Furthermore, in the massage machine of Japanese patent Publication No. 2020-36716, user information and setting information are stored in a storage part. The user information defines attributes such as age, sex and body shape and the like for each user. The setting information defines relations between the above attributes and the massage strength and also associates each of the massage strength with the target detection values of pressure sensors in advance. When the user information is selected based on operation inputs from the user or a user authentication, the massage strength is determined based on the attributes defined in the user information and the setting information, and the target detection values of pressure sensors corresponding to the massage strength are set.

In the massage machine of Japanese Patent Publication No. 2020-36716, for example, the driving of the air cell can be controlled by varying the intake and exhaust time. At this time, the controlling amount of the air cell is adjusted repeatedly such that deviations between the detected value and targeted detection value become small. Thereby, the massage strength set depending on a user now can be given to the user.

### SUMMARY OF THE INVENTION

### Problem to be Solved by Invention

However, depending on the difference in the body shape of a person to be treated, the inflation amount of the airbag required until it contacts to the person to be treated becomes different. Thus, a required air-supplying duration also becomes different. Then, there is the fear, when the person to be treated is rather small or rather slender, that air supply to the airbag ends before the airbag contacts with the person to be treated.

Contemplating the above situation, an object of the present invention aims to make the airbag surely contact with a person to be treated at the time starting the treatment, regardless of the body shape of the person to be treated.

### SUMMARY OF INVENTION

For achieving the above object, a massage machine of one embodiment of the present invention comprises a detection part and a determination part. The detection part detects the pressure of an airbag. The determination part determines, based on the detection result of the detection part, the presence or the absence of contact of the airbag with a person to be treated. When the determination part determines that the contact is present, a treatment by the airbag is started.

Further features and advantages of the present invention will be further cleared by the following embodiments.

### Advantageous Effect of Invention

According to the present invention, regardless of the body shape of a person to be treated, the airbag can be surely made to contact with positions to be treated of the person to be treated at the time starting the treatment.

### BRIEF DESCRIPTION OF THE DRAWINGS

FIG. 1 is the perspective view of chair-type massage machine.

FIG. 2 is the block diagram of controller system for controlling a chair-type massage machine.

FIG. 3A is a schematic view illustrating the arrangement example of piezoelectric element.

FIG. 3B is a schematic view illustrating the arrangement example of inner pressure sensor.

FIG. 3C is a schematic view illustrating the arrangement example of stress sensor.

### DESCRIPTION OF SIGNS

100 . . . (chair-type) massage machine, 101 . . . seat part, 102 . . . backrest part, 1021 . . . pillow part, 1022 . . . treatment unit, 1023 . . . guiding rail, 1024 . . . side-treatment part, 103 . . . base part, 104 . . . armrest part, 105 . . . ottoman, 1061 . . . input part, 1062 . . . storage part, 107 . . . controller part, 1081 . . . actuator group, 1082 . . . pump, 1083 . . . electromagnetic valve group, 1084 . . . airbag group, 1 . . . airbag, 11 . . . air-supply port, 12 . . . air-supply tube, 2 . . . detection part, 21 . . . piezoelectric element, 22 . . . inner pressure sensor, 23 . . . stress sensor, 31 . . . calculation part, 32 . . . determination part, 33 . . . setting part, Ja . . . backrest-rotation axis, Jb . . . ottoman-rotation axis, U . . . person to be treated, Ua . . . cruris part

### EMBODIMENT FOR PRACTICING INVENTION

Herein below, embodiments of the present invention will be described. Now, in the following description, the term “body” means a head part, a neck part and central part other than arms and legs. The term “shoulder part” means the part from the part connecting between a body and arms to the root of neck part. The term “upper arm part” means the part from an elbow (elbow joint) to the shoulder part (shoulder joint) within the arm part. The term “forearm” means the part from a wrist (hand joint) to the elbow (elbow joint) within the arm part. The term “hand” means the part beyond the wrist (hand joint) and means the part from the wrist (hand joint) to tips of fingers. The term “buttock part” means a hip and means the part lower than a lumber part and upper than a femoral part. The term “femoral part” means the part from a hip joint to a knee (knee joint). The term “hip joint” means the joint part connecting between a pelvis and the bone of femoral part (that is, femur). The term “cruris part” means the part from the knee (knee joint) to an ankle. The term “leg part” means the part beyond the ankle (that is, tiptoes).

### 1. Embodiment

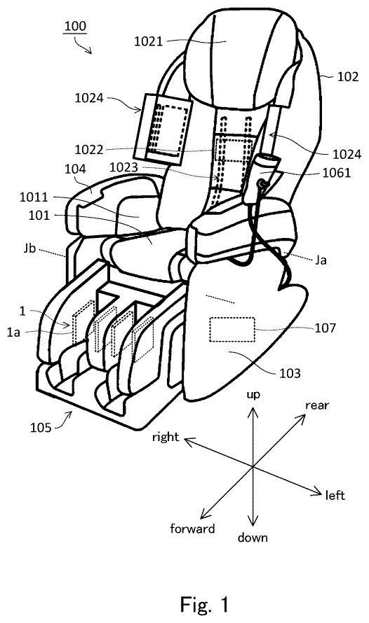

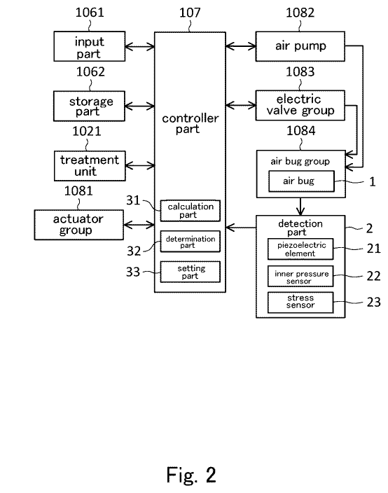

FIG. 1 is the perspective view of a chair-type massage machine 100. FIG. 2 is the block diagram of control system for controlling the operation of chair-type massage machine 100. Hereinafter, the chair-type massage machine 100 may be sometimes referred to “massage machine 100”.

### <1-1. Massage Machine 100>

The massage machine 100 comprises a seat part 101, a backrest part 102, a base part 103 as a left and right pair, an armrest part 104 as a left and right pair, and an ottoman 105.

On the seat part 101, a person to be treated U sits on. The seat part 101 supports the buttock part and the femoral part of person to be treated. Here, to the upper face of seat part 101, an airbag may be placed for treating the lower position of buttock part and the lower position of femoral part etc. of person to be treated U. Furthermore, to a wall part 1011 disposed vertically at both ends along left and right directions of seat part 101, airbags may be disposed for treating the side positions of buttock part at the left and right directions and the side positions of femoral part etc. of the person to be treated.

The backrest part 102 is disposed vertically to the seat part 101 to support the head part and the body part (for example, the shoulder, lumber, and the back of the person to be treated. According to the present embodiment, the backrest part 102 is connected with the rear end of seat part 101. The backrest part 102 is able to rotate relative to the seat part 101 about a backrest-rotation axis Ja extending along the left and right directions. For example, the backrest part 102 may be inclined rearward by rotating to the rear direction from its standing state (reclining). Furthermore, the backrest part 102 may stand up by rotating forward from the rearward-inclined state.

At the upper part of backrest part 102, as shown in FIG. 1, a pillow part 1021 is disposed. The pillow part 1021 supports the head part and the neck part etc. of the person to be treated.

In addition, to the backrest part 102, a treatment unit 1022 and guiding rails 1023 as a left and right pair are enclosed. The treatment unit 1022 may treat the body part and the neck part of the person to be treated. The guiding rails 1023 extend to the longitudinal direction of backrest part 102 along the backrest part 102. Now, the longitudinal direction means, for example, the direction directing from one of the rear end of seat part 101 and the pillow part 1021 to another one. The guiding rails 1023 guide the treatment unit 1022 along the longitudinal direction. Thereby, the treatment unit 1022 may go up and down along the longitudinal direction of backrest part 102 to treat the back and lumber part etc. of the person to be treated.

Besides, to the backrest part 102, a pair of left and right side-treatment parts 1024 is further disposed. The side-treatment parts 1024 are disposed to the left-side end and the right-side end at the forward face of backrest part 102 and protrude forward from the forward face of backrest part 102. To each of the side treatment parts 1024, airbags are disposed. The airbags treat the shoulder part and the upper arm part etc. of the person to be treated. Besides, the massage machine 100 can support the body of person to be treated U (for example, the part between both shoulders) by inflating the airbags each disposed to the left and right pair of side treatment parts 1024.

Furthermore, to the backrest part 102, airbags may be disposed for treating the rear part of body (for example, the rear position of shoulder and the upper position of back and the rear position of lumber part), and airbags may be disposed for treating the pelvis position by pressing the rear position of buttock part.

The base parts 103 are disposed vertically at both left and right sides of seat part 101 and support the armrest part 104.

The armrest parts 104 support the forearm parts and the hands etc. of person to be treated. The armrest parts 104 as a left and right pair have symmetric shapes in left and right, respectively. Now, to each of the armrest part 104, airbags (omitted in the drawing) may be disposed for treating the forearm parts and the hands etc. of the person to be treated U.

The ottoman 105 is disposed near the front end of seat part 101 and receives the cruris part Ua and the leg part etc. of the person to be treated U. The ottoman 105 may rotate about an ottoman-rotation axis Jb. The ottoman-rotation axis Jb extends to left and right directions with passing through the front-end part of the seat part 101 and the upper end part of ottoman 105. According to the present embodiment, the upper end part of ottoman 105 is supported rotatably to the front-end part of seat part 101. To the ottoman 105, an airbag 1 for treating the cruris part Ua of the person to be treated and an airbag for treating the leg part of the person to be treated are disposed.

### <1-2. Control System of Massage Machine 100>

Next, with reference to FIG. 2, the configuration example of control system for the massage machine 100 will be explained. The massage machine 100 further comprises an input part 1061, a storage part 1062, a controller part 107, an actuator group 1081, an air pump 1082, an electromagnetic valve group 1083 and an airbag group 1084.

The input part 1061 receives operation inputs and outputs signals based on the operation inputs to the controller part 107. The operation inputs may include the selection of the information of the person to be treated, the selection of treatment pattern, and the hard and weak adjustment for the treatment and the like. The input part 1061 is connected to the controller part 107 through code lines. The input part 1061 is detachable to a stand (sign omitted). The stand is fixed to the armrest part 104 disposed at the left side of seat part 101.

The storage part 1062 is a non-transitory storage medium keeping the stored information when power supply is stopped. The storage part 1062 stores, for example, programs and data necessary for the controller part 107 to control the operations of massage machine 100. Furthermore, the storage part 1062 stores the information of the person to be treated for identifying the person to be treated and the information of treatment strength. The information of treatment strength is the information defining the level of treatment strength to the person to be treated as well as the standard value of treatment strength.

The controller part 107, for example, is disposed at the lower side of seat part 101 and controls each part of the massage machine 100 based on signals output from the input part 1061. For example, the controller part 107 controls the actuator group 1081, the air pump 1082, and the electromagnetic valve group 1083.

Besides, as shown in FIG. 2, the controller part 107 of massage machine 100 has a calculation part 31, a determination part 32, and a setting part 33. These will be described later.

The actuator group 1081 includes a plurality of actuators. The actuator group 1081 includes, for example, the actuator of backrest part to rotate the backrest part 102, the actuator of ottoman to rotate the ottoman 105 and the like.

The electromagnetic valve group 1083 includes a plurality of electromagnetic valves. A part among the plural electromagnetic valves is disposed between the air pump 1082 and an airbag group 1084 of the massage machine 100 so as to switch the communication/blockage therebetween. Besides, the other part of the plural electromagnetic valve is disposed between the airbag group 1084 and an external part to switch the communication/blockage therebetween.

The airbag group 1084 includes the airbags disposed to each location of the massage machine 100. For example, the airbag group 1084 includes the airbags disposed to the seat part 101, the wall part 1011, the backrest part 102, the side treatment part 1024, the armrest part 104, and the ottoman 105 and the like.

For example, when the air pump 1082 and the airbag is communicated by the part of electromagnetic valves, the airbag becomes inflated by the air supplied by the air pump 1082 through the electromagnetic valve. On the other hand, when the external part and the airbag is made communicated by the other part of electromagnetic valves, the air in the airbag is released to the external part. Thereby, the airbag becomes deflated. Besides, through the operation of each electromagnetic valve, the airbag becomes not communicated to the air pump 1082 as well as the external part, the air volume inside the airbag can be maintained. Other airbags included in the airbag group 1084 run similarly.

### <1-3. Contact Detection of Airbag to Person to be Treated>

Next, the massage machine 100 further has a detection part 2. The detection part 2 detects the pressure of airbag and outputs the signal indicating the detection result to the controller part 107. Here, the pressure detected by the detection part 2 includes, for example, the pressing pressure that is received by the airbag, the inner pressure of airbag (air pressure) and the stress acting to the body part of airbag. Furthermore, the pressing pressure received by the airbag is the pressing pressure that is received by the airbag from the person to be treated U when the airbag becomes contact to the person to be treated U, in other words, the reaction force of the pressing pressure that the airbag exerts to the person to be treated U.

In detail, the detection part 2 detects the pressure of airbag among airbags included in the airbag group 1084, which have gaps to the position to be treated of person to be treated U at the stating time of treatment. In other words, the detection part 2 detects the pressure of airbags that the contact with the person to be treated U are required before starting the treatment. Now, the airbag that is required to detect the contact is preferably a welded airbag and is the bag of which outer peripheries of a pair of base materials overlap each other. However, this exemplification does not exclude the configuration that the airbag to be detected by the detection part 2 is a blow-molded airbag.

Furthermore, as the airbag that the contact detection is required before starting the treatment, for example, airbags for treating the buttock part, the femoral part, the shoulder part, the upper arm, the forearm, the hand, the leg part and cruris part Ua etc. may be included.

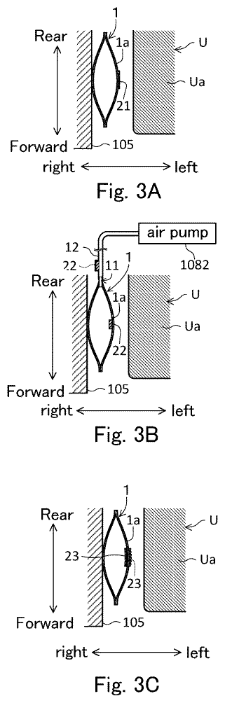

The air bags for treating the left and right direction sides of buttock part and left and right direction sides of femoral part etc., both of which belongs to person to be treated U, are disposed vertically to both sides of the left and right directions of seat part 101. The airbags for treating the shoulder part and the upper arm part of the person to be treated U are disposed to the side treatment part 1024 of backrest part 102. The air bags for treating the forearm part and the hand etc. are disposed to the armrest part 104 to treat the forearm and the hand of person to be treated U. The air bag 1 for treating the leg part and cruris part Ua of the person to be treated U (refer to FIG. 3A-FIG. 3B which are described later) is disposed to the ottoman 105.

Hereinbelow, the contact detection for the airbag 1, which treats the cruris part Ua by being disposed to the ottoman 105, will be described as an example. Now, the detection part 2 can detect the pressure of other air bags of which contact detection is necessary.

When the treatment by the airbag 1 is performed, the detection part 2 detects the pressure of airbag 1. The controller part 107, when performing the treatment by the airbag 1, observes (monitors) the pressure of airbag 1 based on the detection result of detection part 2. For example, the calculation part 31 calculates the changing rate of pressure in the airbag 1 depending on the detection results of detection part 2. Particularly, the calculation part 31 calculates the pressure-rising rate (the amount of pressure rise per unit time duration) of airbag 1. The determination part 32 determines, based on the detection result of detection part 2, the presence or the absence of contact with the person to be treated U by the airbag 1.

The controller part 107 of massage machine 100, when the determination part 32 determines that there is the contact, makes the airbag 1 to start the treatment.

By performing as the above, the massage machine 100, for example, before starting the treatment by the airbag 1, can determine whether or not the airbag 1 becomes contacted with the person to be treated U based on the detection result of detection part 2, depending on its determination result, and can determine whether or not the treatment will be started. Thus, the massage machine 100, regardless of the body shape of the person to be treated, upon starting the treatment, can make the airbag 1 contact surely with the position to be treated. Thus, the person to be treated U, even though it is rather small or rather slender, can receive sufficient treatment by the airbag 1. In other words, the person to be treated can receive the treatment with the massage strength suitable to itself.

In addition, preferably, the determination part 32 determines the presence or the absence of contact based on the pressure-rising rate of airbag 1. For example, the determination part 32, when the pressure-rising rate becomes not less than a threshold value, determines that the airbag 1 becomes contacted with the position to be treated of the person to be treated U.

By performing as the above, when airbag 1 becomes the state sufficient to press the position to be treated, the determination part 32 determines that there is the contact, and the controller part 107 is allowed to start the treatment by the airbag 1. In other words, in the state where the airbag 1 cannot press the position to be treated sufficiently (the state where the airbag 1 slightly contacts with the position to be treated), the determination part 32 can determine that the contact is absent. Therefore, the massage machine 100 can, even though the person to be treated U is rather small or rather slender, under the condition that the contact between the airbag 1 and the position to be treated is surely detected, start the sufficient treatment by the airbag 1.

Furthermore, the setting part 33 sets the treatment strength. For example, the setting part 33, based on the pressure of airbag 1 at the time when the determination part 32 determines the presence of the contact, sets the standard value of treatment strength for airbag 1 to the person to be treated U.

By performing as the above, the massage machine 100, based on the pressure of airbag 1 at the time when the airbag 1 becomes contact with the person to be treated U, can set the standard value for the treatment strength at the airbag 1. For example, the massage machine 100 can set the pressure of airbag 1 at the time becoming contact as the weakest level, for example, as a weak level.

In this time, the storage part 1062 stores the pressure of airbag 1 at the time when the determination part 32 determines that the contact is present with associating the information of the person to be treated U with the standard value of treatment strength to the person to be treated U. That is, the storage part 1062 stores the information of treatment strength by associating with the information of treatment strength. Thereby, the controller part 107 of massage machine 100, upon the person to be treated U is specified by the operation input, performs the treatment operation by the airbag 1 to the person to be treated U under the treatment strength based on the standard value.

By performing as the above, the massage machine 100 is allowed not to detect the contact therebetween every time when the treatment by the airbag 1 is performed to the person to be treated U. That is to say, the massage machine 100 can, by detecting once the contact between the airbag 1 and the position to be treated of the person to be treated U, thereafter by specifying the person to be treated through the operation input, start the treatment by the airbag 1 without performing the detection of the contact.

However, when the massage machine 100 is instructed the re-detection for the contact of airbag 1 with the position to be treated of person to be treated U, the controller part 107 again performs the determination operation of contact and can reset the standard value for the treatment strength of airbag 1. In this time, the storage part 1062 updates and stores the information of treatment strength associated with the information of the person to be treated for the person to be treated.

### <1-4. Detection Part 2>

Next, the detection part 2 may have at least any one of a piezoelectric element 21, an inner pressure sensor 22, and a stress sensor 23, and the present embodiment has any one of among the above (for example, inner pressure sensor 22). FIG. 3A is a schematic view illustrating the arrangement example of piezoelectric element 21. FIG. 3B is a schematic view illustrating the arrangement example of inner pressure sensor 22. FIG. 3C is a schematic view illustrating the arrangement example of stress sensor 23.

Now, FIG. 3A-FIG. 3C are drawings viewed from above, which illustrate the air bag 1a (refer to FIG. 1) among a plurality of airbags 1 disposed to the ottoman 105. Furthermore, FIG. 3A-FIG. 3C are shown, for the purpose of easy viewing of principal parts, by omitting exterior materials such as, for example, a cover and a cushioning material that are disposed on surfaces of each part of the massage machine 100.

The piezoelectric element 21, for example as shown in FIG. 3A, is placed to the face of airbag 1a at the side of position to be treated and detects the contact with the position to be treated by a piezoelectric effect. Now, in FIG. 3A, the position to be treated is the cruris part Ua of the person to be treated U.

By performing as the above, depending on the presence or absence of pressure at the face of airbag 1a facing to the side of position to be treated (for example, the cruris part Ua in FIG. 3A), the contact between the airbag 1a and the position to be treated of the person to be treated U can be detected. At the time when treating by the airbag 1a and if the inflating airbag 1a does not become contact with the position to be treated, the face of airbag 1a at the side of position to be treated is not pressed such that the piezoelectric element 21 does not detect the pressure. Therefore, the determination part 32 determines that the contact is absent. On the other hand, when the inflating airbag 1a becomes contacted with the position to be treated, the face of airbag 1a at the side of position to be treated is pressed such that the piezoelectric element 21 detects the pressure. Thus, the determination part 32 determines that the contact is present and the controller part 107 starts the treatment by the airbag 1a.

The inner pressure sensor 22 detects the inner pressure of airbag 1a. The inner pressure sensor 22, for example, as shown by the hatching enclosed with the solid line of FIG. 3B, is disposed in the airbag 1a. Now, in FIG. 3B, the inner pressure sensor 22 in the airbag 1a is disposed to the inner face of part at the side of the person to be treated U in the body part of airbag 1a. However, not limited to this exemplification, the inner pressure sensor 22 in the airbag 1a may be disposed to the position other than the inner face of part facing to the side of person to be treated U of the body part of airbag 1a, and for example, may be disposed to the inner face at the part of the body part of airbag 1a opposite to the person to be treated U. Alternatively, the inner pressure sensor 22, as shown by the hutching enclosed with the solid line of FIG. 3B, may be disposed to the air-supply tube 12 that connects the air-supply port 11 of airbag 1a with the air pump 1082. In the latter case, the controller part 107 detects the inner pressure of air-supply tube 12 as the inner pressure of airbag 1a. Now, the material of air-supply tube 12 may be, for example, a synthetic resin. However, not limited to this exemplification, the material of air-supply tube 12 may be any material having flexibility. That is, preferably, the air-supply tube 12 is flexibly bendable.

By configuring as the above, the determination part 32, based on the inner pressure of airbag 1a, can detect the contact between the airbag 1a and the position to be treated of person to be treated U (for example, the cruris part Ua in FIG. 3B). Furthermore, the inner pressure sensor 22 may be disposed to the inside of airbag 1a or to the air-supply tube 12 connecting with the airbag 1a. Therefore, the inner pressure sensor 22 can be disposed in a compact size.

The stress sensor 23 detects the stress acting to the airbag 1a. To the stress sensor 23, a strain gauge and the like may be adopted. The stress sensor 23, for example as shown in FIG. 3C, is disposed to the part of body part of airbag 1a facing to the side of person to be treated U. In this time, the stress sensor 23 is disposed to the inner face at the region shown by the hatching enclosed with the solid line of FIG. 3C. Alternatively, the stress sensor 23, as shown by the hatching enclosed with the broken line of FIG. 3C, may be disposed to the outer face at this region. Alternatively, not limited to the above exemplification, the stress sensor 23 may be disposed to the inner face or the outer face of the part of body part of airbag 1a to the opposite side of the person to be treated U.

By configuring as the above, the determination par 32 can, based on the stress acting to the body part of airbag 1a, detect the contact between the airbag 1a and the position to be treated of the person to be treated U (for example, the cruris part Ua in FIG. 3C). Furthermore, by disposing to the inner face of body part, it can be disposed in a compact size.

### 2. Remarks

As the above, the embodiments of the present invention have been described. Now, the above embodiments are exemplifications; the combinations of configuring elements thereof and each of processing may be variously modified, and it should be understood by a person with ordinary skill in the art that such combinations may be fallen in the scope of the present invention.

For example, among the above embodiments, with respect to the pressure detection of airbags included in the airbag group 1084, the airbag 1 disposed to the ottoman 105 has been exemplarily described. However, not limited to this exemplification, in other airbags included in the airbag group 1084, the pressure detection can be performed similarly.

Furthermore, in the above-described embodiments, the chair-type massage machine 100 has been described as an example. However, not limited to this exemplification, the present invention can be applied to, so far as the configuration allows the treatment by airbags, other massage machines other than the chair-type massage machine 100.

In various massage machine including the chair-type massage machine 100, with disposing the airbags including the sensors of detection part 2 (for example, at least any one of the piezoelectric sensor 21, the inner pressure sensor 22, and the stress sensor 23) at the positions contactable with the side positions of person to be treated U at the left and right directions, the detection part 2 can detect the side positions at the left and right directions in the various body locations of person to be treated U. Furthermore, the detection part 2 can detect left and right widths at the various body locations of the person to be treated U. For example, the airbags comprising the sensor of detection part 2 may be disposed to the positions contactable with the left and right-side positions at the shoulder of the person to be treated U. Thereby, the detection part 2 can detect the shoulder width of person to be treated. In addition, the airbags comprising the sensor of detection part 2 may be disposed to the positions contactable with the side positions at the calf part of the person to be treated U. Thereby, the detection part 2 can detect the contact position between the side position of calf part and the airbag. Furthermore, the controller part 107, based on the time history etc. of above-described contact positions stored in the storage part 1062, can detect the swelling of legs of the person to be treated U.

### 3. Summary

Hereinbelow, the embodiments described so far will be comprehensively summarized.

For example, the massage machine 100 disclosed in the specification is configured as the configuration that comprises;
a detection part 2 detecting pressure of an airbag 1, and
a determination part 32 determining, based on a detection result at the detection part 2, presence or absence of contact of the airbag 1 with a person to be treated, wherein
when the determination part 32 determines that the contact is present, treatment by the airbag 1 is started (first configuration).

The massage machine 100 of the first configuration is configured as the configuration that may further comprise;
a calculation part 31 calculating a pressure-rising rate of the airbag, wherein the determination part 32 determines presence or absence of contact based on the pressure-rising rate (second configuration).

In addition, the massage machine 100 of the first configuration or the second configuration is configured as the configuration that may further comprise;
a setting part 33 setting treatment strength, wherein the setting part 33, based on pressure of the airbag 1 at the time when the determination part 32 determines presence of contact, sets a standard value of treatment strength of the airbag 1 to the person to be treated (third configuration).

Furthermore, the massage machine 100 of the third configuration is configured as the configuration that may further comprise;
an input part receiving an operation input 1061, and
a storage part 1062 storing pressure of the airbag 1 when the determination part 32 determines presence of contact by associating information of person to be treated for identifying the person to be treated U with the standard value of treatment strength to the person to be treated U, wherein when the person to be treated is specified by the operation input, treatment operation by the airbag 1 to the person to be treated U is performed at treatment strength based on the standard value (fourth configuration).

Besides, the massage machine 100 having the configuration of any one of the above first to fourth configuration may be configured as the configuration that;
the detection part 2 comprises an inner pressure sensor 22 for detecting an inner pressure of the airbag 1 (fifth configuration).

Besides, the massage machine 100 having the configuration of any one of the above first to fifth configuration may be configured as the configuration that;
the detection part 2 comprises a stress sensor 23 detecting stress acting to the airbag 1 (sixth configuration).

What is claimed is:

1. A massage machine comprising;
a detection part detecting pressure of an airbag, and
a determination part determining, based on a detection result at the detection part, presence or absence of contact of the airbag with a person to be treated,
wherein when the determination part determines that the contact is present, a treatment by the airbag is started.

2. The massage machine of claim 1, further comprising a calculation part calculating a pressure-rising rate of the airbag,
wherein the determination part determines presence or absence of contact based on the pressure-rising rate.

3. The massage machine of claim 1, further comprising a setting part setting treatment strength,
wherein the setting part, based on pressure of the airbag at the time when the determination part determines presence of contact, sets a standard value of treatment strength of the airbag to the person to be treated.

4. The massage machine of claim 3, wherein further comprising an input part receiving an operation input, and
a storage part storing pressure of the airbag when the determination part determines presence of contact by associating information of person to be treated for identifying the person to be treated with the standard value of treatment strength to the person to be treated,
wherein when the person to be treated is specified by the operation input, treatment operation by the airbag to the person to be treated is performed at treatment strength based on the standard value.

5. The massage machine of claim 1, wherein the detection part further comprises an inner pressure sensor for detecting an inner pressure of the airbag.

6. The massage machine of claim 1, wherein the detection part further comprises a stress sensor detecting stress acting to the airbag.
